(19) United States
(12) Patent Application Publication
(10) Pub. No.: US 2021/0318688 A1
(43) Pub. Date: Oct. 14, 2021

(54) MOTION CONTROL APPARATUS, MOTION CONTROL METHOD, NONTRANSITORY COMPUTER READABLE MEDIUM, AND MOTION CONTROL SYSTEM

(71) Applicant: NEC Corporation, Minato-ku, Tokyo (JP)

(72) Inventors: Tatsuya YOSHIMOTO, Tokyo (JP); Hiroshi YOSHIDA, Tokyo (JP)

(73) Assignee: NEC Corporation, Minato-ku, Tokyo (JP)

(21) Appl. No.: 17/272,776

(22) PCT Filed: May 28, 2019
(86) PCT No.: PCT/JP2019/021131

§ 371 Date: Mar. 2, 2021

(30) Foreign Application Priority Data
Sep. 5, 2018 (JP) 2018-165711

(51) Int. Cl. G05D 1/02; B25J 9/10; G05B 19/4155

(52) U.S. Cl. CPC G05D 1/0223; B25J 9/10; E02F 9/2041; G05B 19/4155; G05D 1/0212

(57) ABSTRACT

A motion control apparatus for controlling a control object to follow a target trajectory includes a position acquisition unit that acquires a present position of the control object, and a target trajectory generation unit that generates the target trajectory from the present position to a final position where the control object reaches. The apparatus includes a moving velocity determination unit that determines a moving velocity at which the control object moves in each position on the target trajectory, and a control target position calculation unit that sets a control target position in a traveling direction on a tangent vector of the target trajectory at the present position in order to perform feedback control so that the control object follows the target trajectory at the moving velocity. A control input calculation unit calculates a control input to the control object by the feedback control using the control target position as a target value.

### TECHNICAL FIELD

The present disclosure relates to a motion control apparatus, a motion control method, a non-transitory computer readable medium storing a motion control program, and a motion control system for a work machine operated by a drive apparatus to follow a target trajectory.

### BACKGROUND ART

Recently, the automation of work machines (including mobile bodies, robots, etc.) used in ordinary life and industry has advanced. Actual examples of automation of work machines include not only typical automobiles but also construction machines (e.g., backhoes, bulldozers, dump trucks, etc.) in civil engineering sites, robot arms for works in factories and warehouses, and AGVs (Automatic Guided Vehicle) for carrying loads. These automated work machines are expected to contribute to solving labor shortages, improving work efficiency, and reducing costs.

These work machines perform predetermined operations and movements to achieve desired works. For example, in the case of a backhoe, works such as expansion and contraction of a working arm, opening and closing of a bucket, and turning are combined to carry out operations such as soil excavation, loading soil on a dump truck, and soil slope shaping. Originally, a construction machine is operated by an operator getting on the construction machine and manually operating a lever. Such a delicate work can be realized with high precision and high efficiency by the operator performing detailed lever operations while acquiring the status of the construction machine and the surroundings. In the case of an AGV, the operations such as lifting a load, traveling on a predetermined route, and changing the direction are performed. The method of controlling such operations is realized in various forms such as a manual operation by a remote controller, automatic control by control software incorporated in a vehicle body, and remote automatic control by a remote control apparatus.

In order to realize the operation as described above with high accuracy and high efficiency by automatic control, a drive unit of the work machine must be appropriately controlled so that the work machine draws a desired motion trajectory (hereinafter referred to as a target trajectory). Examples of the drive unit of the work machine include a hydraulic device in a construction machine or a motor of a wheel in the AGV.

The work machines and mobile bodies move continuously in a space, and thus the target trajectory is defined as a continuous line trajectory in the space. However, in common servo system feedback control, the method of converging from the present point in a space to a certain point is mainly used. Therefore, when the continuous target trajectory is followed, the target trajectory is divided into several intermediate target points, and the intermediate target points are sequentially switched from a start point toward an end point of the target trajectory, thereby approximately achieving to follow the target trajectory. Further, the feedback control is characterized in that a control input amount is determined in proportion to an error between a present position and a target point, and thus the acceleration is increased and the work machine moves at a higher velocity as a remaining difference between the present position and the target point becomes larger.

A method of controlling a work machine with moving motions to follow a target trajectory has been studied. The control apparatus of Patent Literature 1 generates a target trajectory from a start point to an end point, estimates a remaining distance from a present position to an end point, calculates, when the present velocity is changed to a target velocity that should be reached at the end point, an acceleration so that a moving distance matches a remaining distance, and corrects the velocity by the calculated acceleration.

### CITATION LIST

### Patent Literature

Patent Literature 1: International Patent Publication No. WO 2012/049866

### SUMMARY OF INVENTION

### Technical Problem

In the method disclosed in Patent Literature 1, an intermediate target point (a control target position) is set on the target trajectory, and the acceleration is calculated according to the remaining distance from the present position to the intermediate target point. When a movable unit passes the intermediate target point, the acceleration of the movable unit may vary greatly depending on the estimated remaining distance, i.e., the distance to the next intermediate target point, and there is a possibility that the movable unit may not move smoothly.

An object of the present disclosure is to provide a motion control apparatus, a motion control method, a motion control program, and a motion control system for controlling a control object to smoothly move on a target trajectory and to follow the target trajectory with high accuracy and at a high velocity.

### Solution to Problem

A first example aspect of the present disclosure is a motion control apparatus for controlling a control object to follow a target trajectory, the motion control apparatus including: a position acquisition unit configured to acquire a present position of the control object; a target trajectory generation unit configured to generate the target trajectory from the present position to a final position where the control object reaches; a moving velocity determination unit configured to determine a moving velocity at which the control object moves in each position on the target trajectory; a control target position calculation unit configured to set a control target position in a traveling direction on a tangent vector of the target trajectory at the present position in order to perform feedback control so that the control object follows the target trajectory at the moving velocity; and a control input calculation unit configured to calculate a control input to the control object by the feedback control using the control target position as a target value.

A second example aspect of the present disclosure is a motion control method performed by a motion control apparatus to control a control object to follow a target trajectory. The motion control method performed by the motion control apparatus includes: acquiring a present position of the control object; generating the target trajectory from the present position of the control object to a final position; determining a moving velocity at which the control object moves in each position on the target trajectory; setting a control target position in a traveling direction on a tangent vector of the target trajectory at the present position in order to perform feedback control so that the control object follows the target trajectory at the moving velocity; and calculating a control input to the control object by the feedback control using the control target position as a target value.

A third example aspect of the present disclosure is a motion control program for controlling a control object to follow a target trajectory. The motion control program causes a computer to execute: a process of acquiring a present position of the control object; a process of generating the target trajectory from the present position of the control object to a final position; a process of determining a moving velocity at which the control object moves in each position on the target trajectory; a process of setting a control target position in a traveling direction on a tangent vector of the target trajectory at the present position in order to perform feedback control so that the control object follows the target trajectory at the moving velocity; and a process of calculating a control input to the control object by the feedback control using the control target position as a target value.

A fourth example aspect of the present disclosure is a motion control system comprising a control object and a motion control apparatus connected to the control object via a communication network. The motion control apparatus includes: a position acquisition unit configured to acquire a present position of the control object; a target trajectory generation unit configured to generate the target trajectory from the present position to a final position where the control object reaches; a moving velocity determination unit configured to determine a moving velocity at which the control object moves in each position on the target trajectory; a control target position calculation unit configured to set a control target position in a traveling direction on a tangent vector of the target trajectory at the present position; and a control input calculation unit configured to calculate a control input to the control object by the feedback control using the control target position as a target value.

### Advantageous Effects of Invention

According to the present disclosure, it is possible to provide a motion control apparatus, a motion control method, a motion control program, and a motion control system for controlling a control object to smoothly move on a target trajectory and to follow the target trajectory with high accuracy and at a high velocity.

### BRIEF DESCRIPTION OF DRAWINGS

FIG. 1 is a block diagram showing an example of a motion control apparatus according to the present disclosure;

FIG. 2 is a block diagram showing an example of a motion control system S according to a first example embodiment of the present disclosure;

FIG. 3 is a block diagram showing an example of the motion control system S according to the first example embodiment of the present disclosure;

FIG. 4 is a block diagram showing an example of a hardware configuration of a control unit of a motion control apparatus according to the first example embodiment of the present disclosure;

FIG. 5 is a block diagram showing an example of a work machine according to the first example embodiment of the present disclosure;

FIG. 6 is a diagram for explaining an example of a method of calculating a control target position according to the first example embodiment of the present disclosure;

FIG. 7 is a diagram for explaining an example of a method of updating the control target position according to the first example embodiment of the present disclosure;

FIG. 8 shows an example of calculation of a target trajectory and the control target position according to the first example embodiment of the present disclosure;

FIG. 9 is a flowchart for explaining processing of the motion control apparatus in a motion control method according to the first example embodiment of the present disclosure;

FIG. 10 is a flowchart for explaining the processing of the motion control apparatus in the motion control method according to the first example embodiment of the present disclosure; and

FIG. 11 is a flowchart for explaining processing of the work machine in the motion control method according to the first example embodiment of the present disclosure.

### DESCRIPTION OF EMBODIMENTS

Example embodiments of the present disclosure will be described below with reference to the drawings.

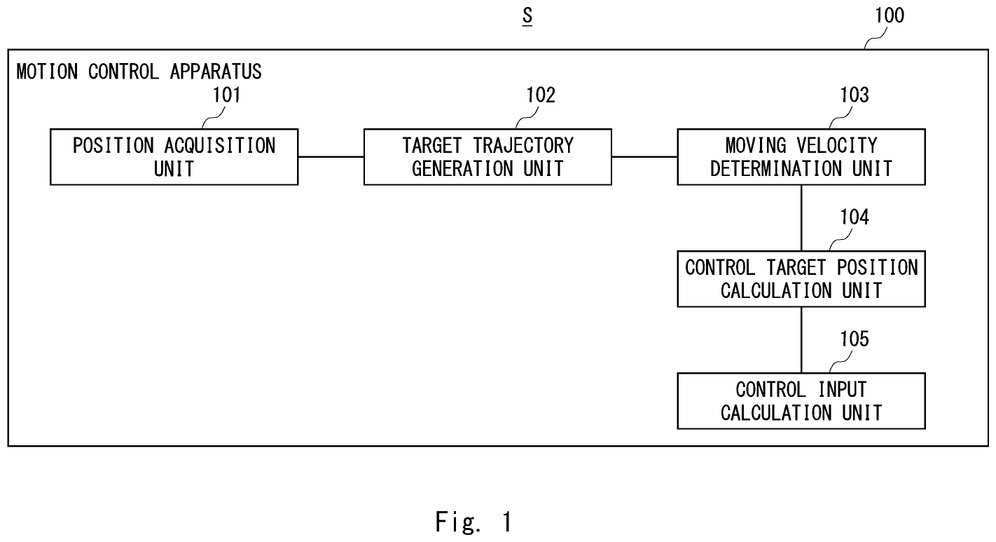

FIG. 1 is a block diagram showing an example of a motion control apparatus 100 according to the present disclosure. As shown in FIG. 1, the motion control apparatus 100 for controlling a control object to follow a target trajectory includes a position acquisition unit 101, a target trajectory generation unit 102, a moving velocity determination unit 103, a control target position calculation unit 104, and a control input calculation unit 105.

The position acquisition unit 101 acquires a present position of the control object. The target trajectory generation unit 102 generates a target trajectory from the present position to a final position where the control object reaches. The moving velocity determination unit 103 determines a moving velocity at which the control object moves in each position on the target trajectory. The control target position calculation unit 104 sets a control target position in a traveling direction on a tangent vector of the target trajectory at the present position in order to perform feedback control so that the control object follows the target trajectory at the moving velocity. The control input calculation unit 105 calculates a control input to the control object by the feedback control using the control target position as a target value.

By doing so, the motion control apparatus according to the present disclosure can control the control object to smoothly move along the target trajectory by the feedback control.

### First Example Embodiment

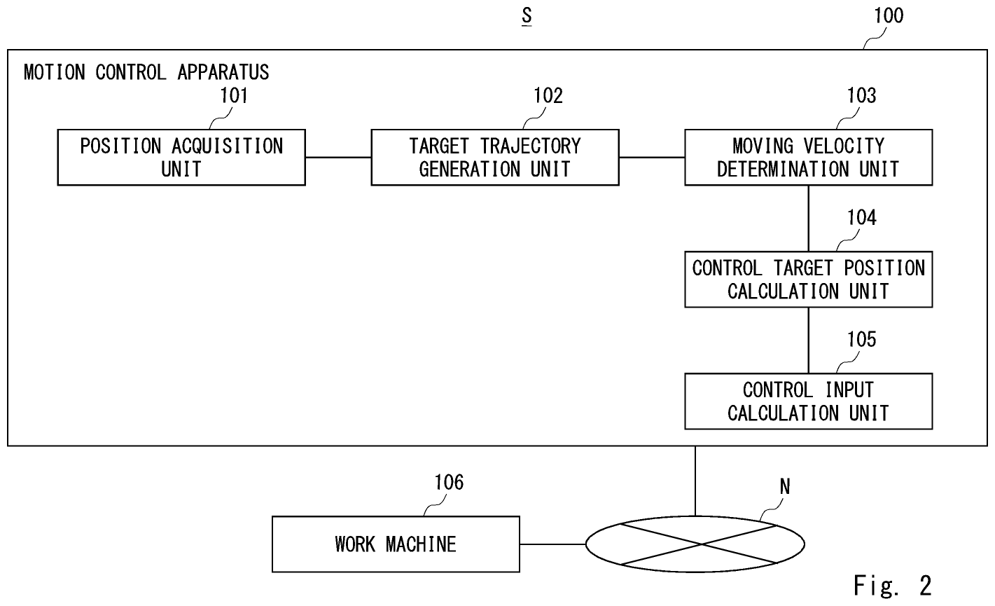

FIG. 2 is a block diagram showing an example of a motion control system S according to the present disclosure. In this example, unlike FIG. 1, the motion control apparatus 100 is connected to a work machine 106 via a communication network N in such a way that the motion control apparatus 100 can communicate with the work machine 106, which is a control object. The motion control system S includes the motion control apparatus 100, the communication network N, and the work machine 106. A control input from the motion control apparatus 100 is transmitted to the work machine 106 via the communication network to thereby control the work machine 106.

The position acquisition unit 101 acquires position information about the work machine 106 at the present time (e.g., the position and posture of a vehicle body in a space).

The target trajectory generation unit 102 generates the target trajectory in which the work machine moves from the present position to the final position. The details of the definition of the target trajectory will be described later.

The moving velocity determination unit 103 determines a parameter for specifying a moving velocity at each point on the target trajectory when the work machine 106 moves on the target trajectory. The moving velocity specification parameter will be described later.

The control target position calculation unit 104 determines the control target position for controlling the work machine 106 to follow the target trajectory by the feedback control for each position on the target trajectory. The control target position is determined on a tangent vector to the present position on the target trajectory, which is a position in the traveling direction deviating from the target trajectory. Preferably, the control target position is on the tangent vector to the present position on the target trajectory, and is determined in proportion to the moving velocity specifying parameter determined by the moving velocity determination unit 103. Details of the method of calculating the control target position will be described later.

The control input calculation unit 105 sets the control target position according to the present position of the work machine 106, and calculates the control input that converges to the control target position.

In the motion control system S including the motion control apparatus 100 according to the present disclosure, based on the present position of the work machine 106 obtained by the position acquisition unit 101, the target trajectory generation unit 102 generates the target trajectory in which the work machine 106 moves from the present position to the final position. The moving velocity determination unit 103 specifies the moving velocity by the parameter according to a passing-through point of the target trajectory, and the control target position calculation unit 104 calculates the control target position on the tangent vector to the present position in the traveling direction deviating from the target trajectory according to the moving velocity specification parameter. The control input calculation unit 105 calculates the control input converging to the control target position and inputs it to the work machine 106 via the communication network N. By doing so, the work machine 106 can be smoothly moved along the target trajectory. In addition, the work machine 106 can follow the target trajectory with high accuracy at the specified moving velocity. That is, it is possible to control the work machine 106 to follow the target trajectory with high accuracy and at a high velocity.

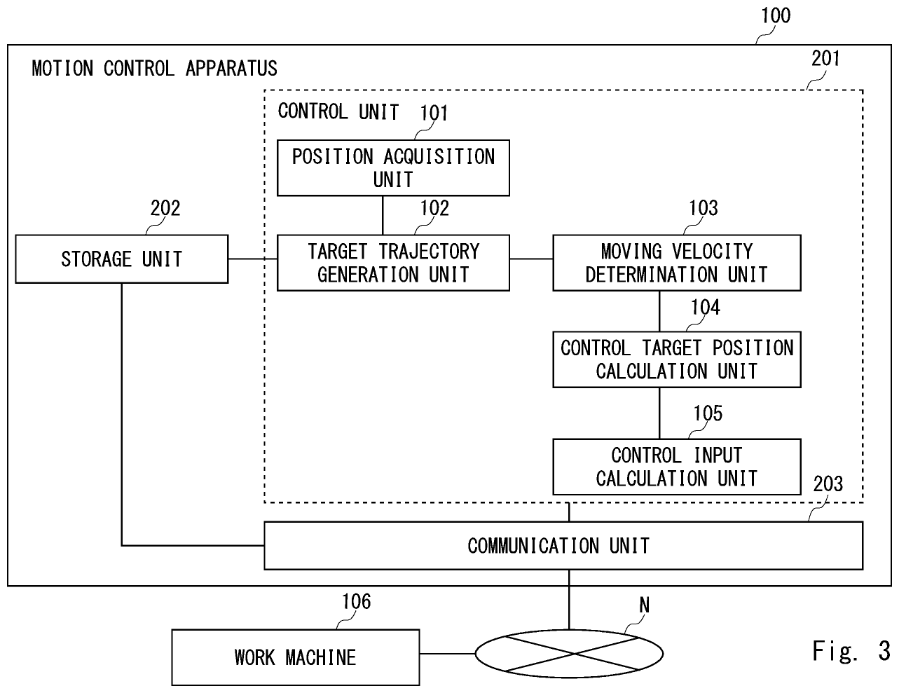

The motion control apparatus 100 according to the first example embodiment of the present disclosure will be described. FIG. 3 is a block diagram showing an example of the motion control system S according to the first example embodiment. The motion control apparatus 100 according to the first example embodiment is a communication control apparatus for automatically controlling the work machine 106 such as a construction machine, for example, at a civil engineering site by a computer.

As shown in FIG. 3, the motion control apparatus 100 includes a control unit 201, a storage unit 202, and a communication unit 203. The control unit 201 includes the position acquisition unit 101, the target trajectory generation unit 102, the moving velocity determination unit 103, a control target position calculation unit 104, and the control input calculation unit 105. The motion control apparatus 100 is connected to the communication network N. The motion control apparatus 100 is connected to the work machine 106 via the communication network N in such a way that the motion control apparatus 100 can communicate with the work machine 106. The motion control apparatus 100 controls the work machine 106 to follow the target trajectory.

The communication network N includes, for example, a local communication system such as a specific low-power radio and a wireless LAN (Wi-Fi), a carrier line such as 4G and 5G, and IP communication via the Internet (Internet Protocol). In this example embodiment, the method of configuring the communication network N may be any method as long as the motion control apparatus 100 can perform data communication with the work machine 106 via the communication unit 203.

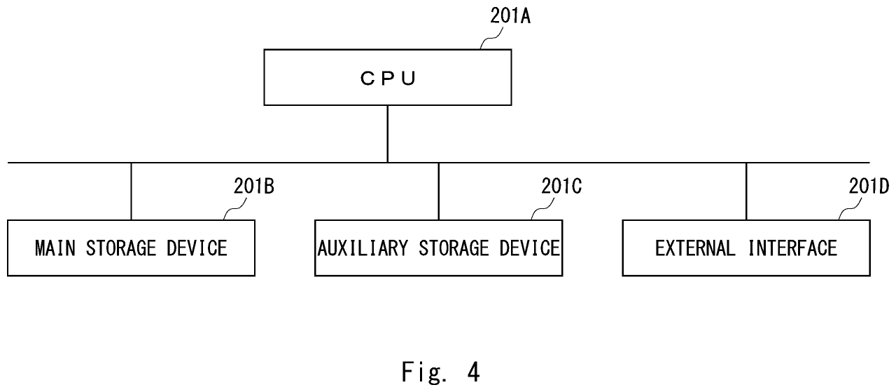

FIG. 4 is a block diagram showing an example of a hardware configuration of the control unit of the motion control apparatus according to the first example embodiment of the present disclosure. As shown in FIG. 4, the control unit 201 includes a CPU (Central Processing Unit) 201A, a main storage device 201B, an auxiliary storage device 201C, and an external interface 201D. When the CPU 201A executes a motion control program, the processing of each unit of the motion control apparatus 100 is executed. The motion control program is stored, for example, in the auxiliary storage device 201C. The CPU 201A reads the program from the auxiliary storage device 201C, deploys the program in the main storage device 201B, and executes processing in accordance with the program. When the CPU 201A executes the motion control program, the control unit 201 functions as the position acquisition unit 101, the target trajectory generation unit 102, the moving velocity determination unit 103, the control target position calculation unit 104, and the control input calculation unit 105. Note that the position acquisition unit 101, the target trajectory generation unit 102, the moving velocity determination unit 103, the control target position calculation unit 104, and the control input calculation unit 105 may be implemented by different pieces of hardware.

The auxiliary storage device 201C is an example of a non-transitory computer readable tangible medium. Other examples of the non-transitory computer readable media include magnetic disks, magneto-optical disks, CD-ROMs (Compact Disk Read Only Memories), DVD-ROMs (Digital Versatile Disk Read Only Memories), and semiconductor memories connected via the external interface 201D. When the program is distributed to the control unit 201 via a communication line, the control unit 201 which have received the program may deploy the program in the main storage device 201B and execute the above processing.

The program may be for implementing a part of the processing in the motion control apparatus 100. Further, the program may be a differential program for implementing processing in the motion control apparatus 100 by combining it with other programs already stored in the auxiliary storage device 201c.

Also, some or all of the constituent elements of the motion control apparatus 100 may be implemented by general-purpose or dedicated circuitry, processors, etc., or a combination thereof. These constituent elements may be composed of a single chip or a plurality of chips connected via a bus. Some or all of the constituent elements may be implemented by a combination of the circuitry, the program, and the like described above.

As shown in FIG. 3, the storage unit 202 stores the processing result of the CPU 201A. The storage unit 202 stores the position information of the work machine 106 received via the communication unit 203 described later, target trajectory information generated by the target trajectory generation unit 102, a moving velocity adjustment parameter determined by the moving velocity determination unit 103, control target position information calculated by the control target position calculation unit 104, and control input information calculated by the control input calculation unit 105.

The communication unit 203 transmits and receives predetermined data to and from the work machine 106 connected to the communication network N. In communication with the work machine 106, a control input signal calculated by the control input calculation unit 105 and stored in the storage unit 202 is transmitted, and the position information sensed by the work machine 106 is received. The type of communication data handled by the communication unit 203 is determined by the form of the automatic control or the communication device to be used, and is not particularly limited.

The position acquisition unit 101 receives the position information from the work machine 106 via the communication unit 203, and acquires the position information stored in the storage unit 202 about the present time of the work machine 106. Examples of the position information include position coordinates on the two-dimensional plane coordinates of the work machine 106 or work points (e.g., the position of the bucket edge of the backhoe) of the work machine. The content of the position information can be determined according to the type of the work machine 106 and the control purpose, and is not limited to them.

The target trajectory generation unit 102 generates the target trajectory up to the final position based on the present position information of the work machine 101 acquired by the position acquisition unit 106. The target trajectory is a continuous trajectory from the present position to the final position in space coordinates and is defined by a function which uses a time t as a parameter. That is, the target trajectory in the N-dimensional space is defined as a vector on the N-dimensional coordinates as shown in the following Formula (1).

x(t)=(x₁(t), . . . ,x_{N}(t)) [Formula 1]

The moving velocity determination unit 103 determines a moving velocity value for specifying the moving velocity when the work machine 106 follows the target trajectory. Since the moving velocity is determined for each position x(t) on the target trajectory, the moving velocity is defined as a moving velocity function v(t) which uses the time t as a parameter in a manner similar to the target trajectory. The moving velocity v(t) is used when the control target position calculation unit 104, which will be described later, calculates the control target position.

The control target position calculation unit 104 calculates the control target position corresponding to a control target value in the feedback control so that the work machine 106 follows the target trajectory. The control target position varies depending on the present position of the work machine 106, and is updated in accordance with the movement of the work machine 106 to thereby enable the work machine 106 to follow the target trajectory. Therefore, the control target position is defined as a function r(t) which uses the time t as a parameter, in a manner similar to the target trajectory. The method of calculating the control target position will be described later in detail.

The control input calculation unit 105 calculates the control input such that the work machine 106 moves in the control target position direction by the feedback control using the control target position r(t) calculated by the control target position calculation unit 104 as the control target value. Here, the control input may be, for example, an inclination angle of an operation lever in a construction machine, an indicated rotational velocity of a motor for controlling a hydraulic control valve. In the feedback control, the control input for moving the work machine 106 from the present position to the control target position direction is calculated. As an example of the method of calculating the control input, with an error e(t) between the position x(t) at the time t of the work machine 106 and the control target position r(t) calculated as e(t)=r(t)−x(t), the control input u(t)=Ke(t). The coefficient K is a gain parameter and may be designed by a model-based control method that considers the dynamic characteristics of the work machine 106 such as the pole placement method and the optimal regulator method. Note that such a method of calculating the control input is merely an example, and the present disclosure is not limited to this.

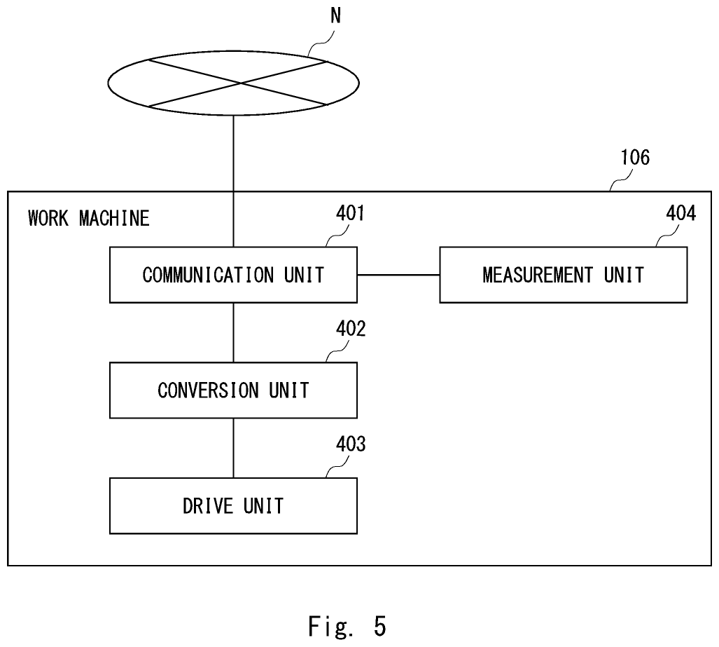

FIG. 5 is a block diagram showing an example of the work machine according to the first example embodiment of the present disclosure. The work machine 106 is, for example, a construction machine such as a backhoe, a bulldozer, and a dump truck. Specifically, as shown in FIG. 5, the work machine 106 includes a communication unit 401, a conversion unit 402, a drive unit 403, and a measurement unit 404. The work machine 106 is connected to the motion control apparatus 100 (FIGS. 1 to 3) via the communication network N in such a way that the motion control apparatus 100 can communicate with the work machine 106. The work machine 106 may include a CPU (not shown), a storage unit (not shown), and so on. By the CPU executing a program stored in the storage unit, all processes in the work machine 106 may be achieved. In this case, the programs stored in the respective storage units of the work machine 106 include codes for achieving the processes in respective constituent elements of the work machine 106 by being executed by the CPU.

The communication unit 401 transmits and receives predetermined data to and from the motion control apparatus 100 connected via the communication network N. Specifically, the communication unit 401 receives information about the control input of the work machine 106 transmitted from the communication unit 203 of the motion control apparatus 100, and transmits the position information of the work machine 106 observed by the measurement unit 404.

The conversion unit 402 converts the information about the control input of the work machine 401 received by the communication unit 106 into a drive signal. The drive signal varies depending on the drive device for controlling the work machine 106. The drive signal corresponds to, for example, a current value of a cylinder of an external lever control apparatus in a driver's seat, and a current value of a motor for controlling a hydraulic control valve inside the work machine 106.

The drive unit 403 is a drive device such as a motor for controlling the cylinder and the hydraulic control valve provided in the work machine 106. The drive unit 403 operates in accordance with the drive signal (the current value, etc.) input from the conversion unit 402 to control each drive mechanism (the bucket, arm, boom, turning mechanism, etc., in the backhoe) of the work machine 106 in accordance with the control input received from the motion control apparatus 100.

The measurement unit 404 measures information such as the position of the work machine 106 by a sensor at every fixed time intervals. The information to be measured includes, for example, the angle and the turning angle of the arm in the backhoe. The form of the information to be measured may depend on the sensor used, and the form is not limited. For example, the form of the measurement information may be analog data such as a current value and a voltage value or encoded digital data.

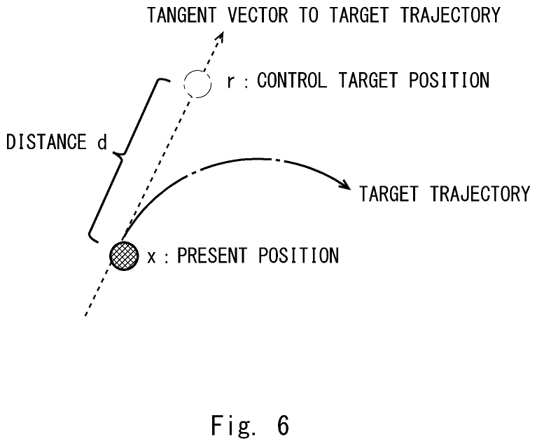

Next, a method of calculating the control target position by the control target position calculation unit 104 will be described with reference to FIG. 6. As described above, the control input calculation unit 105 calculates the control input such that the work machine 106 moves in the direction of the control target position, and transmits the control input to the work machine 106 through the communication unit 203 to thereby control the work machine 106. That is, when the work machine 106 is controlled to follow the target trajectory, the control target position is always set from the present position in the traveling direction of the target trajectory. By updating the control target position every control cycle in accordance with the movement, the work machine 106 can be controlled to follow the target trajectory. Therefore, in order to enable the work machine 106 to follow the target trajectory, the control target position calculation unit 104 may set the control target position in the moving direction on the tangent vector to the present position of the target trajectory as shown in FIG. 6. Note that the term “on the tangent vector” used in the present specification does not mean strictly on a tangent line, and instead means within a range having a constant width from the tangent line as long as the effect of the present disclosure is achieved

The distance between the present position x(t) of the work machine 106 and the control target position r(t) at the time t is defined as d(t). Since the distance d(t) corresponds to the above-described error e(t), the value of the control input u(t) increases in proportion to the distance d(t). That is, when the distance d(t) is increased, the moving velocity of the work machine 106 is increased. On the other hand, when the distance d(t) is reduced, the moving velocity of the work machine 106 is reduced. Therefore, since the magnitude of the value of the distance d(t) is proportional to the moving velocity of the work machine 106, the value of the distance d(t) can be calculated as the proportional value d(t) of the moving velocity v(t) determined by the moving velocity determination unit 103, i.e., d(t)=αv(t) (α>0). Since the distance d(t) is proportional to the moving velocity v(t), the distance d(t) may also be referred to as a moving velocity function in the following description.

The formula for calculating the control target position r(t) by the control target position calculation unit 104 is defined by the following Formulas (2) and (3).

$$\begin{matrix}[ Formula 2 ] \\ r ( t ) = x ( t ) + \frac{dx}{dt} \cdot w ( t ) & ( 2 ) \\ [ Formula 3 ] \\ w ( t ) = \frac{d ( t )}{‖ \frac{dx}{dt} ‖} & ( 3 )\end{matrix}$$

According to Formula (2), the control target position r(t) is calculated by adding a relative position term, which is obtained by multiplying the tangent vector of the target trajectory by a norm w(t), to the present position x(t) of the work machine 106. The norm w(t) is calculated by dividing the distance d(t) by the Euclidean norm of the tangent vector according to Formula (3).

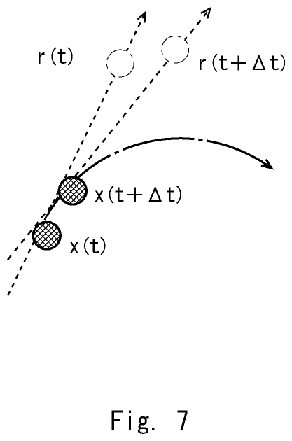

The control target position calculation unit 104 sequentially updates the control target position every control cycle (time Δt) in accordance with the movement of the work machine 106 in order to control the work machine 106 to follow the target trajectory. As shown in FIG. 7, while the work machine 106 is moved from the present position x(t) to x(t+Δt) after the lapse of time Δt from the certain time t, the feedback control is performed using the control target position r(t). When the work machine 106 reaches x(t+Δt), the position x(t+Δt) of the work machine 106 after the movement and a new distance d(t+Δt) are used to calculate a new control target position r(t+Δt) according to Formulas (2) and (3).

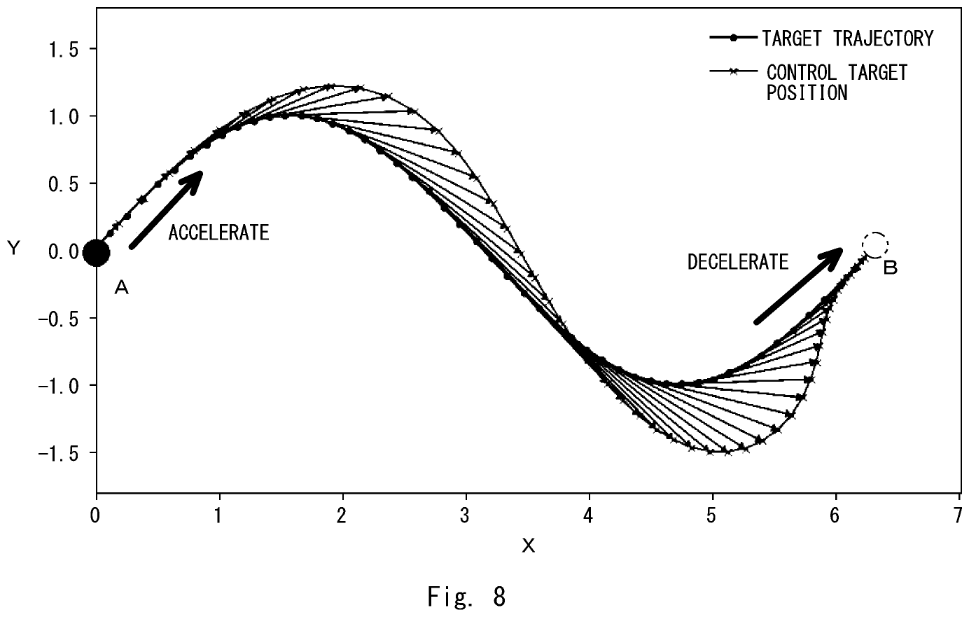

FIG. 8 shows an example of calculating the control target position for a certain target trajectory. FIG. 8 shows an example of the movement of the work machine 106 on a two-dimensional plane consisting of X and Y axes. When the present position of the work machine 106 is defined as a point A, the target trajectory generation unit 102 generates a target trajectory to a point B which is the final position. In this example, as shown in FIG. 8, all the target trajectories are formed of curves, but the present disclosure is not limited to this, and only a part of the target trajectory may be curved. The moving velocity determination unit 103 determines the velocity v(t) at which the work machine 106 moves in each position on the target trajectory. In the example of FIG. 8, the velocity v(t) at the point A is 0, and the velocity v(t) is increased as the work machine 106 travels in the direction of the point B (in other words, the work machine 106 accelerates). The velocity v(t) decreases as the work machine 106 approaches the point B, and when the work machine 106 reaches the point B, the velocity v(t) becomes 0 (in other words, the work machine 106 decelerates and stops at the point B).

At this time, the control target position (Reference) is generated on the tangent vector to each position on the target trajectory and in the traveling direction (indicated by the arrows in FIG. 8) of the work machine using the moving velocity function d(t) as shown in the above Formulas (2) and (3). Since the distance between the generated control target position and the present position is d(t)=αv(t), the distance is calculated in proportion to the moving velocity v(t) determined by the moving velocity determination unit 103. That is, the distance d between the control target position and the present position at the point A is 0, and the velocity v(t) increases as the work machine 106 travels in the direction of the point B, so that the distance d between the control target position and the present position also increases. Since the velocity v(t) decreases as the work machine 106 approaches the point B, the distance d between the control target position and the present position also decreases, and when the work machine 106 reaches the point B, the velocity v(t) is set to 0 (in other words, the work machine 106 decelerates and stops at the point B).

As described with reference to FIG. 8, by sequentially updating the control target position every control cycle in accordance with the movement of the work machine 106, the work machine 106 can be controlled to follow the target trajectory with high accuracy and at a high velocity. Further, the work machine 106 can be smoothly moved. In order for the work machine to follow the target trajectory without deviating from it, ideally, the control cycle should be set as short as possible (i.e. infinitely close to 0). Preferably, the control cycle is set in such a way that the distance for which the work machine travels in the control target position direction during one control cycle is shorter than a predetermined allowable error from the target trajectory that should be followed by the work machine.

As described above, the motion control apparatus 100 periodically repeats the processing of the position acquisition unit 101, the target trajectory generation unit 102, the moving velocity determination unit 103, the control target position calculation unit 104, and the control input calculation unit 105, which are the constituent functions of the control unit 201, to thereby enable the work machine 106 to follow the target trajectory.

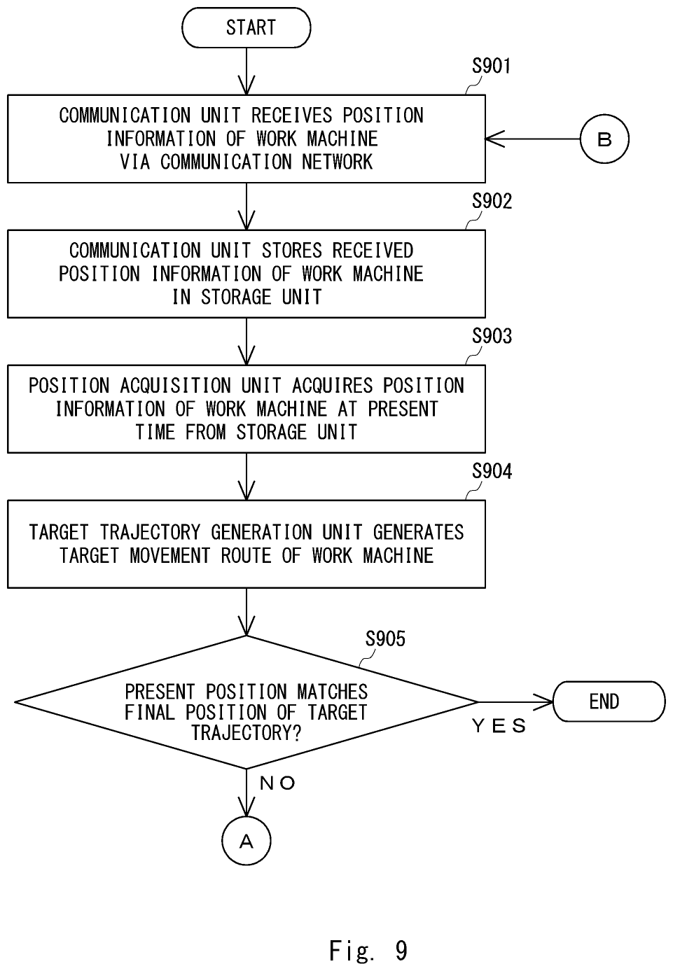

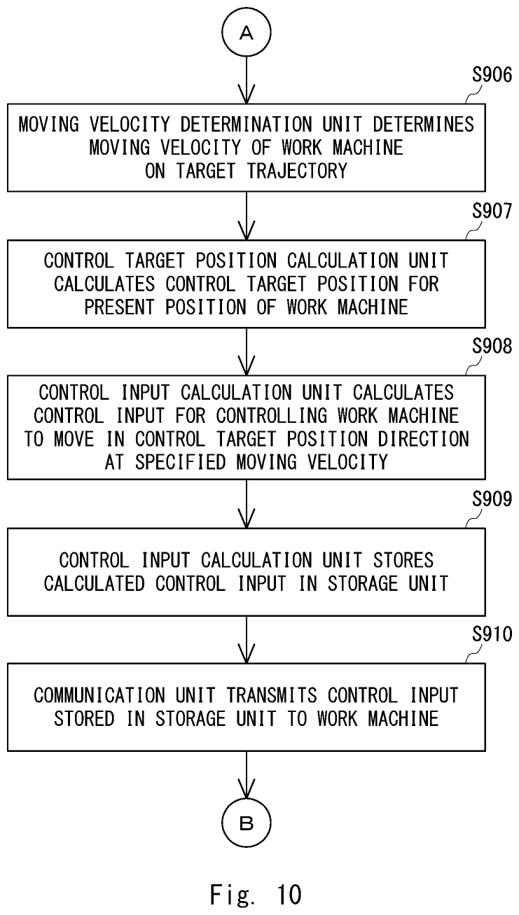

Next, the progress of processing according to this example embodiment will be described. FIGS. 9 and 10 are flowcharts showing an example of the progress of processing of the motion control apparatus 100 according to the first example embodiment.

First, the communication unit 203 receives the position information of the work machine 106 at the present time via the communication network N (Step S901). The communication unit 203 also stores the received position information in the storage unit 202 (Step S902).

Next, the progress of processing of each constituent function in the control unit 201 will be described. The position acquisition unit 101 acquires the position information of the work machine at the present time stored in the storage unit 202 in Step S902 (Step S903).

The target trajectory generation unit 102 generates the target trajectory, which is a future target movement route, from the present position of the work machine acquired in Step S903 to the final position (Step S904).

The control unit 201 compares the present position of the work machine 106 acquired by the position acquisition unit 101 in Step S904 with the final position of the target trajectory generated by the target trajectory generation unit 102 in Step S903. If a result of the comparison between them does not indicate a match, the control unit 201 proceeds to a process A, whereas if the result of the comparison between them indicates a match, the control unit 201 ends the processing (Step S905).

The moving velocity determination unit 103 determines the moving velocity function v(t) that specifies the moving velocity when the work machine 106 moves on the target trajectory generated by the target trajectory generation unit 102 in Step S904 (Step S906).

The control target position calculation unit 104 uses the target trajectory generated in Step S904 and the moving velocity function v(t) determined in Step S906, and calculates the control target position r(t) for the present position of the work machine 106 based on Formulas (2) and (3) (Step S907).

The control input calculation unit 105 calculates the control input for controlling the work machine 106 to move in the control target position direction calculated in Step S907 at the moving velocity determined in Step S906 (Step S908). Further, the control input calculation unit stores the control input calculated in Step S908 in the storage unit 202 (Step S909).

In Step S909, the communication unit 203 acquires the latest control input stored in the storage unit 202 and transmits it to the work machine 106 via the communication network N (Step S910).

The series of processing steps of the motion control apparatus 100 described above are continuously executed on the computer at every fixed control cycle. That is, after the processing of Step S910 is completed, the process returns to the processing of Step S901, and the subsequent processes are repeated. The processing to determine an end of the processing of the motion control apparatus 100 is as described above in Step S905.

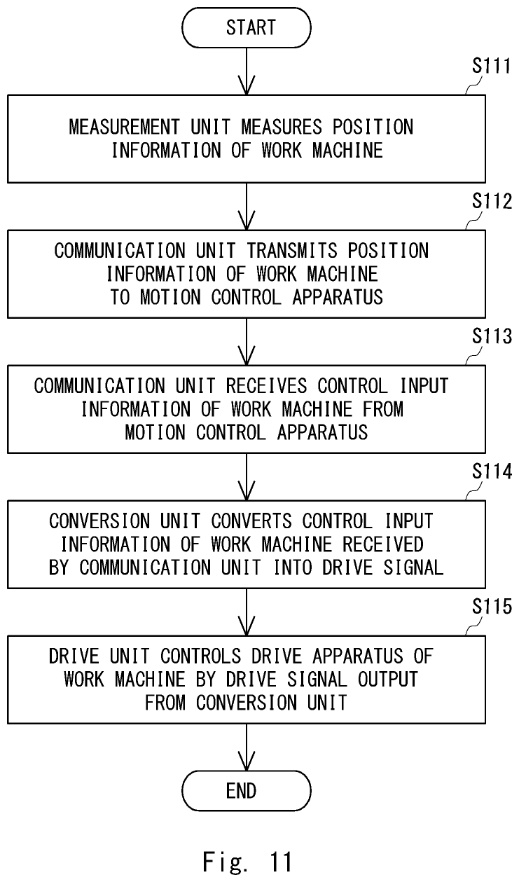

Next, an example of the progress of the processing of the work machine 106 according to the first example embodiment will be described with reference to the flowchart of FIG. 11.

The measurement unit 404 measures the position information of the work machine 106 at the present time (Step S111). The position information includes a plurality of pieces of information such as an absolute position of the work machine 106 and the posture of each driving mechanism, and these pieces of information are measured at the same time.

Next, the communication unit 401 of the work machine 106 transmits the present position information of the work machine 106 measured by the measurement unit 404 in Step S111 to the motion control apparatus 100 via the communication network N (Step S112). Further, the communication unit 401 receives the control input information for controlling the work machine 106 to follow the target trajectory from the motion control apparatus 100 via the communication network N (Step S113).

The conversion unit 402 converts the control input information of the work machine 106 acquired in Step S113 into a drive signal (Step S114). The drive signal varies depending on the type of the drive device for controlling the work machine 106. The drive signal corresponds to, for example, a current value of a cylinder of an external lever control apparatus in a driver's seat, and a current value of a motor for controlling a hydraulic control valve. The drive signal is input to the drive unit 403 through an electronic circuit in the machine body of the work machine 106.

The drive unit 403 operates in accordance with the drive signal (e.g., the current value) input from the conversion unit 402, thereby operating each drive mechanism of the work machine 106 (Step S115). Examples of the drive mechanism of the work machine 106 controlled by the drive unit 403 include a bucket, an arm, a boom, and a turning mechanism in a backhoe. As described above, there may be a plurality of drive mechanisms of the work machine 106, and different drive signals may be transmitted to the respective drive mechanisms and controlled independently of each other.

A series of processing steps in the work machine 106 is continuously executed at predetermined time intervals. That is, if the processing to follow the target trajectory by the motion control apparatus 100 is not completed, the process returns to Step S111 again. On the other hand, the motion control apparatus 100 completes the processing to follow the target trajectory and performs stop processing (e.g., powering off the engine, etc.), thereby ending the processing step of the work machine 106.

According to the motion control apparatus 100 of the first example embodiment described above, the target trajectory generation unit 102 generates the target trajectory in which the work machine 106 moves, and the moving velocity determination unit 103 determines the moving velocity of the work machine 106. In addition, the motion control apparatus 100 sets the control target position in the traveling direction on the tangent vector of the target trajectory at the present position so that the control target position calculation unit performs the feedback control so that the work machine 106 follows the target trajectory at the moving velocity. Further, the motion control apparatus 100 calculates the control input for moving at a moving velocity in the traveling direction of the target trajectory. By doing so, the motion control apparatus 100 can control the work machine 106 to move accurately on a desired target trajectory at a desired moving velocity. It is thus possible to provide the motion control apparatus 100, the motion control method, the motion control program, and the motion control system S which can control the work machine 106 to follow the target trajectory with high accuracy and at a high velocity.

### Other Example Embodiments

In the examples described above, an example in which the motion control apparatus controls the work machine via the network has been described. However, the present disclosure is not limited to this, and the motion control apparatus and the work machine may be integrated.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Compact Disc-Read Only Memory), CD-R (CD-Recordable), CD-R/W (CD-ReWritable), DVD (Digital Versatile Disc), BD (Blu-ray (registered trademark) Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the exemplary embodiments disclosed above can be described as, but not limited to, the following supplementary notes.

### (Supplementary Note 1)

A motion control apparatus for controlling a control object to follow a target trajectory, the motion control apparatus comprising:

a position acquisition unit configured to acquire a present position of the control object;

a target trajectory generation unit configured to generate the target trajectory from the present position to a final position where the control object reaches;

a moving velocity determination unit configured to determine a moving velocity at which the control object moves in each position on the target trajectory;

a control target position calculation unit configured to set a control target position in a traveling direction on a tangent vector of the target trajectory at the present position in order to perform feedback control so that the control object follows the target trajectory at the moving velocity; and

a control input calculation unit configured to calculate a control input to the control object by the feedback control using the control target position as a target value.

### (Supplementary Note 2)

The motion control apparatus according to Supplementary note 1, wherein

a distance between the control target position and the present position set by the control target position calculation unit is calculated in proportion to the moving velocity determined by the moving velocity determination unit.

### (Supplementary Note 3)

The motion control apparatus according to Supplementary note 1 or 2, wherein

at least a part of the target trajectory is curved.

### (Supplementary Note 4)

The motion control apparatus according to any one of Supplementary notes 1 to 3, wherein

the control target position calculation unit updates the control target position every control cycle in accordance with a movement of the control object.

### (Supplementary Note 5)

The motion control apparatus according to Supplementary note 4, wherein

the control cycle is set such that a distance for which the control object travels in a direction of the control target position during one control cycle is shorter than a predetermined allowable error from the target trajectory followed by the control object.

### (Supplementary Note 6)

A motion control method performed by a motion control apparatus to control a control object to follow a target trajectory, the motion control method performed by the motion control apparatus comprising:

acquiring a present position of the control object;

generating the target trajectory from the present position of the control object to a final position;

determining a moving velocity at which the control object moves in each position on the target trajectory;

setting a control target position in a traveling direction on a tangent vector of the target trajectory at the present position in order to perform feedback control so that the control object follows the target trajectory at the moving velocity; and

calculating a control input to the control object by the feedback control using the control target position as a target value.

### (Supplementary Note 7)

A non-transitory computer readable medium storing a motion control program for controlling a control object to follow a target trajectory, the motion control program causing a computer to execute:

a process of acquiring a present position of the control object;

a process of generating the target trajectory from the present position of the control object to a final position;

a process of determining a moving velocity at which the control object moves in each position on the target trajectory;

a process of setting a control target position in a traveling direction on a tangent vector of the target trajectory at the present position in order to perform feedback control so that the control object follows the target trajectory at the moving velocity; and

a process of calculating a control input to the control object by the feedback control using the control target position as a target value.

### (Supplementary Note 8)

A motion control system comprising a control object and a motion control apparatus connected to the control object via a communication network, wherein

the motion control apparatus comprises:

a position acquisition unit configured to acquire a present position of the control object;

a target trajectory generation unit configured to generate the target trajectory from the present position to a final position where the control object reaches;

a moving velocity determination unit configured to determine a moving velocity at which the control object moves in each position on the target trajectory;

a control target position calculation unit configured to set a control target position in a traveling direction on a tangent vector of the target trajectory at the present position; and

a control input calculation unit configured to calculate a control input to the control object by feedback control using the control target position as a target value.

### (Supplementary Note 9)

The motion control system according to Supplementary note 8, wherein

the motion control apparatus is configured to transmit the control input to the control object via the communication network,

the control object is configured to measure position information of the control object at the present time and transmit the position information of the control object to the motion control apparatus via the communication network,

the control object is configured to receive the control input from the motion control apparatus, and convert the control input into a drive signal for driving a drive unit of the control object, and

the drive unit is configured to operate a drive mechanism of the control object at a speed based on the drive signal.

Although the present disclosure has been described above with reference to the example embodiments, the present disclosure is not limited by the above. Various changes can be made to the configuration and details of the present disclosure that can be understood by a person skilled in the art within the scope of the invention.

This application is based upon and claims the benefit of priority from Japanese patent application No. 2018-165711, filed on Sep. 5, 2018, the disclosure of which is incorporated herein in its entirety by reference.

### REFERENCE SIGNS LIST

100 MOTION CONTROL APPARATUS
101 POSITION ACQUISITION UNIT
102 TARGET TRAJECTORY GENERATION UNIT
103 MOVING VELOCITY DETERMINATION UNIT
104 CONTROL TARGET POSITION CALCULATION UNIT
105 CONTROL INPUT CALCULATION UNIT
106 WORK MACHINE
201 CONTROL UNIT
201A CPU
201B MAIN STORAGE DEVICE
201C AUXILIARY STORAGE DEVICE
201D EXTERNAL INTERFACE
202 STORAGE UNIT
203 COMMUNICATION UNIT
401 COMMUNICATION UNIT
402 CONVERSION UNIT
403 DRIVE UNIT
404 MEASUREMENT UNIT
N COMMUNICATION NETWORK
S MOTION CONTROL SYSTEM

What is claimed is:

1. A motion control apparatus for controlling a control object to follow a target trajectory, the motion control apparatus comprising:
at least one memory storing instructions, and
at least one processor configured to execute the instructions to;
acquire a present position of the control object;
generate the target trajectory from the present position to a final position where the control object reaches;
determine a moving velocity at which the control object moves in each position on the target trajectory;
set a control target position in a traveling direction on a tangent vector of the target trajectory at the present position in order to perform feedback control so that the control object follows the target trajectory at the moving velocity; and
calculate a control input to the control object by the feedback control using the control target position as a target value.

2. The motion control apparatus according to claim 1, wherein
a distance between the control target position and the present position set by the control target position calculation means is calculated in proportion to the moving velocity determined by the moving velocity determination means.

3. The motion control apparatus according to claim 1, wherein
at least a part of the target trajectory is curved.

4. The motion control apparatus according to claim 1, wherein the at least one processor configured to execute the instructions to;
update the control target position every control cycle in accordance with a movement of the control object.

5. The motion control apparatus according to claim 4, wherein
the control cycle is set such that a distance for which the control object travels in a direction of the control target position during one control cycle is shorter than a predetermined allowable error from the target trajectory followed by the control object.

6. A motion control method performed by a motion control apparatus to control a control object to follow a target trajectory, the motion control method comprising:
acquiring a present position of the control object;
generating the target trajectory from the present position of the control object to a final position;
determining a moving velocity at which the control object moves in each position on the target trajectory;
setting a control target position in a traveling direction on a tangent vector of the target trajectory at the present position in order to perform feedback control so that the control object follows the target trajectory at the moving velocity; and
calculating a control input to the control object by the feedback control using the control target position as a target value.

7. (canceled)

8. A motion control system comprising a control object and a motion control apparatus connected to the control object via a communication network, wherein
the motion control apparatus comprises:
at least one memory storing instructions, and
at least one processor configured to execute the instructions to;
acquire a present position of the control object;
generate the target trajectory from the present position to a final position where the control object reaches;
determine a moving velocity at which the control object moves in each position on the target trajectory;
set a control target position in a traveling direction on a tangent vector of the target trajectory at the present position; and
calculate a control input to the control object by feedback control using the control target position as a target value.

9. The motion control system according to claim 8, wherein
the motion control apparatus is configured to transmit the control input to the control object via the communication network,
the control object is configured to measure position information of the control object at the present time and transmit the position information of the control object to the motion control apparatus via the communication network,
the control object is configured to receive the control input from the motion control apparatus, and convert the control input into a drive signal for driving a drive unit of the control object, and
the drive unit is configured to operate a drive mechanism of the control object at a speed based on the drive signal.
